(19) United States
(12) Patent Application Publication
(10) Pub. No.: US 2011/0191357 A1
(43) Pub. Date: Aug. 4, 2011

(54) MAP DATA, STORAGE MEDIUM AND NAVIGATION APPARATUS

(75) Inventors: Tsuyoshi TANAKA, Chiryu-city (JP); Takayuki Matsunaga, Hachioji-city (JP)

(73) Assignee: DENSO CORPORATION, Kariya-city (JP)

(21) Appl. No.: 13/014,175

(22) Filed: Jan. 26, 2011

(30) Foreign Application Priority Data
Jan. 29, 2010 (JP) 2010-19100
Sep. 21, 2010 (JP) 2010-210928

(51) Int. Cl. G06F 17/30

(52) U.S. Cl. 707/752; 707/E17.018

(57) ABSTRACT

Map data is disclosed. The map data includes a multilink information list, a road name information list and an offset information list. The multilink information list has fixed-length multilink information elements each indicting a number of links contained in a corresponding multilink. The road name information list has road name information elements each indicating a road name of corresponding multilink information element. The road name information elements are arranged in the road name information list in an order in which the corresponding multilink information elements are arranged in the multilink information list. The offset information list has fixed-length offset information elements each indicating location of a corresponding road name information element in the road name information list. The offset information elements are arranged in the offset information list in an order in which the corresponding multilink information elements are arranged in the multilink information list.

### CROSS REFERENCE TO RELATED APPLICATION

The present application is based on and claims priority to Japanese Patent Applications No. 2010-19100 filed on Jan. 29, 2010 and No. 2010-210928 filed on Sep. 21, 2010, disclosures of which are incorporated herein by reference.

### BACKGROUND OF THE INVENTION

1. Field of the Invention

The present invention relates to map data for a navigation apparatus, a computer readable storage medium storing map data, and a navigation apparatus having map data.

2. Description of Related Art

A KIWI/A format is generally used in Japan as a map data format for a navigation apparatus. In the KIWI/A format, roads on a map are expressed in units of link, and each link has start node reference information and end node reference information. The map data in the KIWI/A format is hierarchized into multiple levels in order to speed up route retrieval etc. A link ID acting as identification information is assigned to each link in the lowest level. In particular, for purpose of efficient drawing of roads having the same attribute and data compression etc., a group of continuous links having the same attribute is defined as a multilink (also called herein a link string). Link IDs with consecutive values are assigned to the group of links forming a multilink. Because of this, when a multilink is expressed in an upper level, links between a start point and a end point of the multilink can be identified based on a link ID of a link corresponding to the start point of the multilink and a link ID of a link corresponding to the end point of the multilink.

A map data format such as the KIWI/A format and the like is optimized for an application that separates and individually utilizes route retrieval data and map drawing data, so that a system can have an enhanced accessibility and a short processing time.

JP 2004-126036-A1 corresponding to US 2006/0155462-A1 describes integration of acquired data without duplication, in order to reduce volume of distribution map data including road name data. Specifically, the road map data includes road data having road position information and background data having road name information, and the road data and the background data are divided into data pieces according to multiple meshes. Based on the road map data, a route from a start point to an end point of a road is determined. The route passes through and is contained in some meshes. The road data and the background data that represent the route are extracted. Name information elements contained in the extracted meshes are integrated into name data without duplication. From the extracted road data and the integrated name data, the distribution map data is created.

According to the technique described in JP 2004-126036-A1 corresponding to US 2006/0155462-A1, since the road map data includes the road data and the background data divided according to multiple meshes, and since the acquired map data itself contains duplicative data, size of the map data is disadvantageously large.

As for map data for countries other than Japan, the map data typically has search-dedicated data in addition to the road name data so that a destination can be designated based on street addresses. Thus, the map data has disadvantageously large volume. Furthermore, when the data is integrated into dictionary data, the dictionary data becomes large, and data access speed is reduced.

### SUMMARY OF THE INVENTION

The present invention is made in view of the foregoing. It is an objective of the present invention to provide map data for a navigation apparatus, the map data having a small data volume and enabling high speed access to data. It is also objective of the present invention to provide a computer readable storage medium storing therein such map data and a navigation apparatus having such map data.

According to a first aspect of the present invention, there is provided map data in which roads are expressed in units of link and a group of continuous links having a same attribute is defined as a multilink. The map data includes a multilink information list, a road name information list and an offset information list. The multilink information list stores therein fixed-length multilink information elements which respectively correspond to multilinks in such manner that each of the multilink information elements indicates a number of links contained in a corresponding one of the multilinks. The multilink information elements are arranged in the multilink information list in a multilink storage order. The road name information list stores therein road name information elements which respectively correspond to the multilink information elements in such manner that each of the road name information elements indicates a road name of corresponding one of the multilink information elements. The road name information elements are arranged in the road name information list in an order in which the corresponding multilink information elements are arranged in the multilink information list. The offset information list stores therein fixed-length offset information elements which respectively correspond to the road name information elements in such manner that each of the offset information elements indicates location of a corresponding one of the road name information elements in the road name information list, wherein the offset information elements are arranged in the offset information list in an order in which the corresponding multilink information elements are arranged in the multilink information list.

According to the above map data, it is possible to provide the map data having a small data volume and enabling high speed access to data.

According to a second aspect of the present invention, there is provide map data in which roads are expressed in units of link and a group of continuous links having a same attribute is defined as a multilink. The map data includes a multilink information list, a road name information list and an offset information list. The multilink information list stores therein fixed-length multilink information elements which respectively correspond to multilinks in such manner that each of the multilink information elements indicates a number of links contained in a corresponding one of the multilinks. The multilink information elements are arranged in the multilink information list in a multilink storage order. The road name information list stores therein road name information elements which respectively correspond to the multilink information elements in such manner that each of the road name information elements indicates a road name of a corresponding one of the multilink information elements. The road name information elements are arranged in the road name information list in an order that is defined as a preset arrangement order of a symbol set. The offset information list stores therein fixed-length offset information elements which respectively correspond to the road name information elements in such manner that each of the offset information elements indicates location of a corresponding one of the road name information elements in the road name information list. The offset information elements are arranged in the offset information list in an order in which the corresponding multilink information elements are arranged in the multilink information list.

According to the above map data, it is possible to provide the map data having a small data volume and enabling high speed access to data.

According to a third aspect of the present invention, a computer readable storage medium storing therein the above map data is provided. According to a fourth aspect of the present invention, a navigation apparatus having, the above map data is provided.

### BRIEF DESCRIPTION OF THE DRAWINGS

The above and other objects, features and advantages of the present invention will become more apparent from the following detailed description made with reference to the accompanying drawings. In the drawings:

FIG. 1 is a diagram illustrating a data structure of map data;

FIG. 2 is a diagram illustrating a data structure of an integrated file;

FIG. 3 is a diagram illustrating a relationship among a road management information list, a′ link information list and a coordinate information list;

FIG. 4 is a diagram illustrating a relationship among a road management information list, a road name ID list, and name dictionary data;

FIG. 5 is a diagram illustrating a relationship between a link information list and an address range information list.

FIG. 6 is a diagram illustrating a data structure of name dictionary data;

FIG. 7 is a flowchart illustrating a road name acquisition process;

FIG. 8 is a flowchart illustrating a address search process; and

FIG. 9 is a block diagram illustrating navigation apparatus.

### DETAILED DESCRIPTION OF EMBODIMENTS

Embodiments of the present invention will be described below with reference to the accompanying drawings. It should be noted that embodiments of the present invention are not limited to the below-described embodiments and can have various forms.

<1. Map Data Outline>

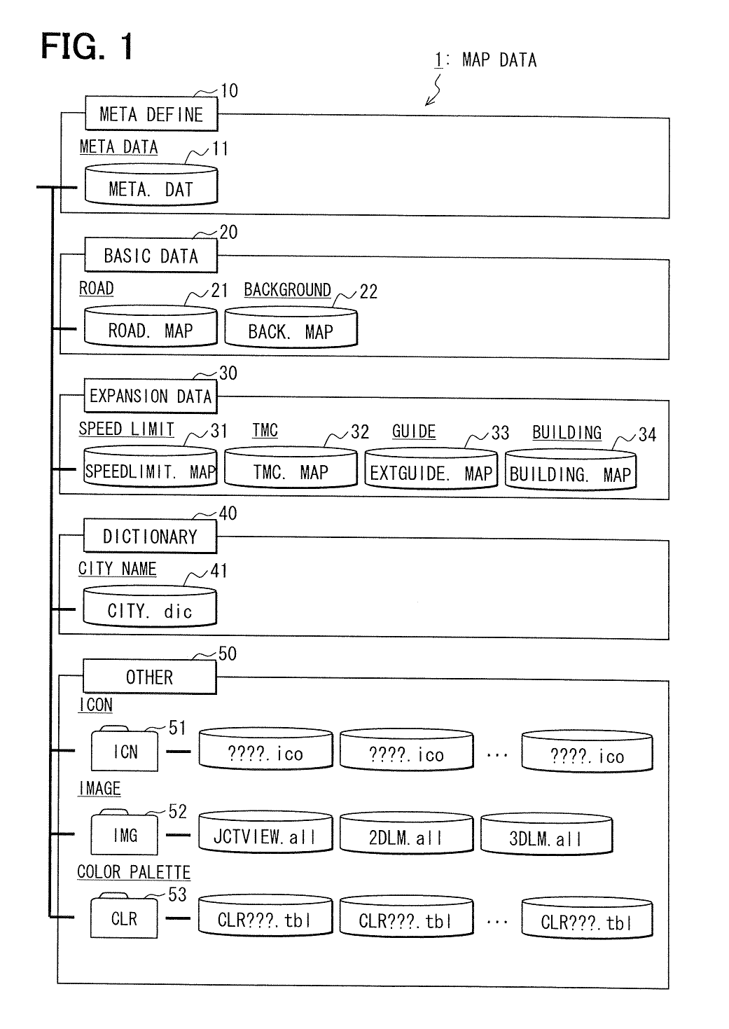

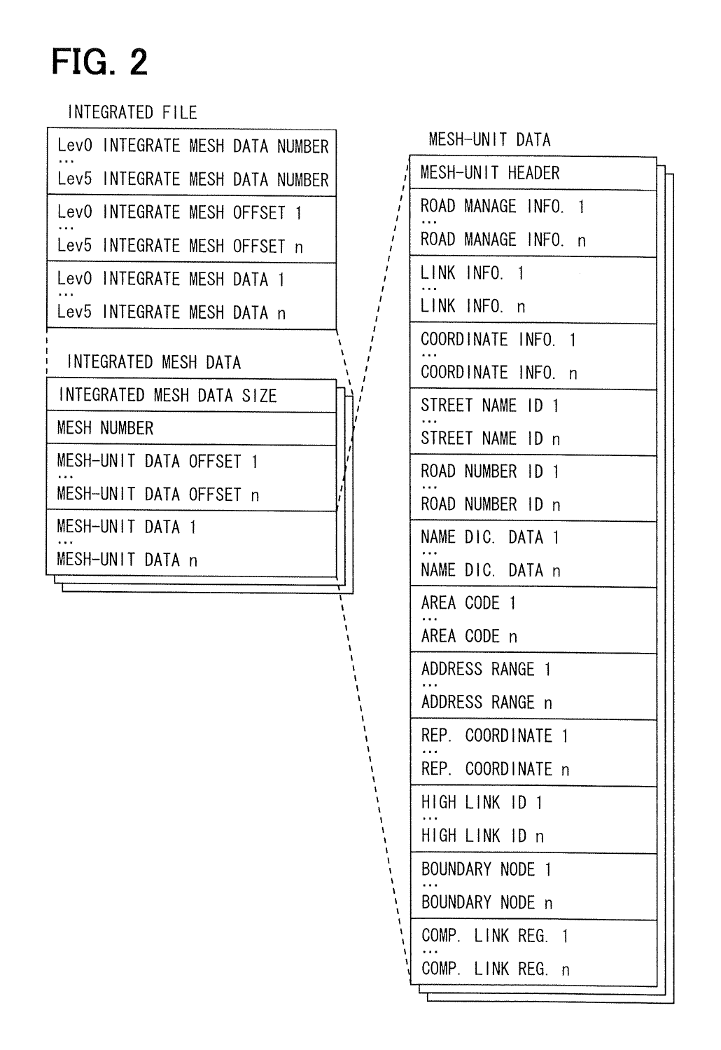

Map data 1 of the present embodiment will be described with reference to FIGS. 1 and 2. FIGS. 1 and 2 illustrate a basic structure of the map data 1.

The map data 1 has the following features.

(1) File Structure

Files included in the map data 1 are classified into meta definition data 10, basic data 20, expansion data, 30, dictionary data 40, and other data 50. As shown in FIG. 1, the meta definition data 10 includes meta data 11. The basic data 20 includes road data 21 and background data 22. The expansion data 30 includes speed limit information 31, TMC (traffic message channel) information 32, guidance and lane information 33 and building and landmark information 34. The dictionary data 40 includes city name dictionary 41. The other data 50 includes icon definition 51, image definition 52 and color palette definition 53.

The meta data 11 stores structure information of record data. The road data 21 stores information about road network. The background data 22 stores information about background in terms of, for example, plane, line, point or the like. The speed limit information 31 stores information about speed limit. The TMC information 32 stores information about TMC (traffic message channel). The guidance and lane information 33 stores information about guidance and information about lane. The building and landmark information stores information about building and information about landmark. The city name dictionary 41 stores information about city name in a dictionary format. The icon definition 51 stores information about icon. The image definition 52 stores information about image. The color palette definition 53 stores information about color palette.

(2) Mesh Structure

According degree of details, the map data 1 is generated and recorded on a level-by-level basis (from level 0 to level 5). In the map data 1, mesh data are organized in units of integrated mesh data. Each integrated mesh data is formed from integration of a reference mesh and surrounding meshes so that the number of surrounding meshes is level-dependent. The level 5 is the lowest degree of details and can act as wide-area data. The level 0 is the high degree of details and can act as detailed data.

(3) Integrated File Structure

The above-described basic data 20 and expansion data 30 (which include the road data 21, the background data 22, the speed limit information 31, the TMC information 32, the guidance and lane information 33 and the building and landmark information 34) are organized in units of integrated file. Each integrated file is formed from integration of the integrated mesh data.

As shown in FIG. 2, the above-described integrated file includes: an integrated mesh data number list, which is a list of integrated mesh data numbers of respective levels; an integrated mesh offset list, which is a list of integrated mesh offsets of respective levels; and an integrated mesh data list, which is a list of integrated mesh data of respective levels. The integrated mesh data number of each level stores the number of integrated mesh data contained in the each level, and is 4 bytes in size. The integrated mesh data number list, which has 6 integrated mesh data numbers of respective level, and is 24 byte in size. The integrated mesh offset of each level stores an offset (byte location) to the integrated mesh data of the each level, and is 4 bytes in size. If the integrated mesh data of a certain level does not exist, the integrated mesh offset of the certain level stores a null value (0xFFFFFFFF). The integrated mesh offset list, which has 6 integrated mesh offsets of respective levels, is 24 bytes in size.

As shown in FIG. 2, each integrated mesh data includes integrated mesh data size information, mesh number information, a mesh-unit data offset list, and a mesh-unit data list. The integrated mesh data size information stores information on the total size of the integrated mesh data, and is 4 bytes in size. The mesh number information stores information on the number of meshes contained in a map region corresponding to the integrated mesh date, and is 2 bytes in size. The mesh-unit data offset list is a list of mesh-unit data offsets 1 to n. Each mesh-unit data offset “i” stores an offset (i) to mesh-unit data “i” (ii) from the beginning of the integrated mesh data of this level, where “i” is integer from 1 to n. A mesh-unit data offset stores a null value (0xFFFFFFFF) if a mesh corresponding to the mesh-unit data offset does not exist.

Content of mesh-unit data varies depending on data types. Since the present embodiment relates to the road data 21, the road data 21 and the mesh-unit data of the road data 21 will be specifically described below.

(4) Road Data

Let us consider a case where the above-described integrated file forms the road data 21. As shown in FIG. 2, each mesh-unit data, which is a portion of the integrated mesh data contained in the integrated file, includes a mesh-unit header, a road management information list, a link information list, a coordinate information list, a street name ID list (referred to also as road name ID list), a road number name list, name dictionary data (referred to also as city name dictionary), an area code list, an address range information list, a representative coordinate information list, an upper-level link ID list, a boundary node number list, and a composite link regulation record list.

The mesh-unit header stores the number of records in each of the lists (e.g., the road management information list) contained in the mesh-unit data. Every data contained in the mesh unit header is fixed-length. Thus, the mesh unit header itself is fixed-length.

The road management information list stores fixed-length road management information elements. The road management information elements respectively correspond to multilinks. Herein, the multilink is a group of continues links having the same attribute. In the present embodiment, it is assumed that the multilink is a group of continues links having the same road name. Each road management information element indicates the number of links contained in a corresponding one of the multilinks. In the road management information list, the road management information elements are arranged in a given (predetermined) order called a multilink storage order. In the above, the road management information list is an example of a multilink information list. The road management information elements are examples of multilink information elements.

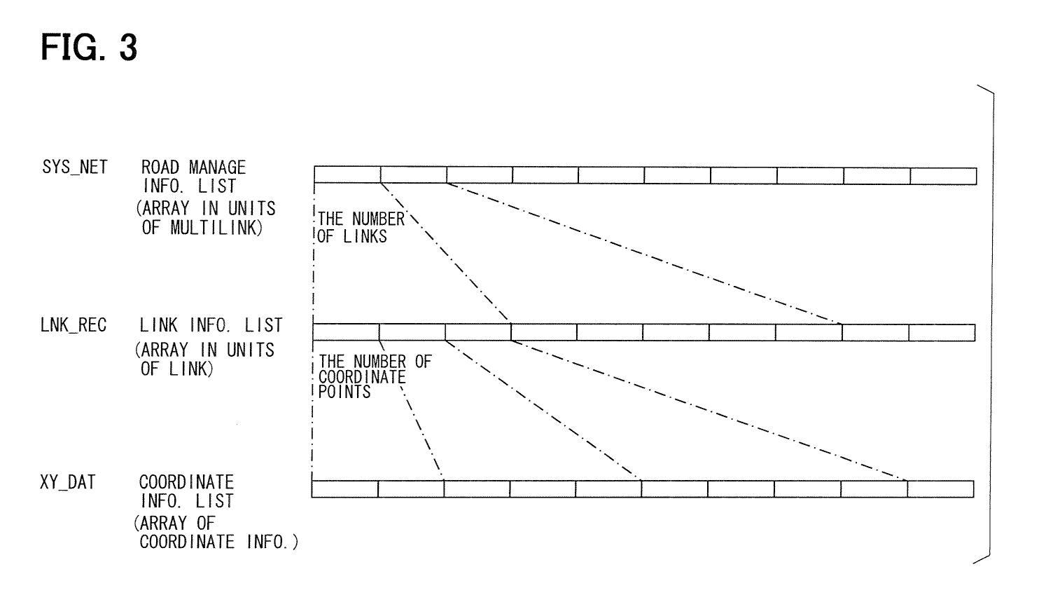

The link information list is a list of link information elements. The link information elements respectively correspond to links. Each link information element is fixed-length and indicates the number of coordinate points that are set on a corresponding one of the links to indicate shape of the corresponding one of the links. As shown in FIG. 3, the link information elements can be divided into multiple groups of link information elements. The multiple groups respectively correspond to the road management information elements in the road management information list. For example, the first road management element is associated with a first group of link information elements (i.e., the first to third link information elements) since the first road management element represents a certain multilink formed by links “a”, “b” and “c”, and the link information elements in the first group represents respective links “a”, “b” and “c”. In the link information list, the link information elements are arranged so that the multiple groups of link information elements are arranged in the same order as the road management information elements are arranged in the road management information list. Further, as shown in FIG. 3, the link information elements in each group are arranged in an order in which the corresponding links are designated in the multilink.

The coordinate information list is a list of fixed-length coordinate information elements, each indicating a coordinate point that is set on a link to indicate position and shape of the link. The coordinate information elements are divided into multiple groups that respectively correspond to the link information elements in the link information list (see FIG. 3). Thus, each group of coordinate information elements corresponds to one link. In the coordinate information list, the groups of coordinate information elements are arranged in the same order as the corresponding link information elements are arranged in the link information list. In each group, the fixed-length coordinate information elements may be arranged in an order in which the corresponding coordinate points are set on the link.

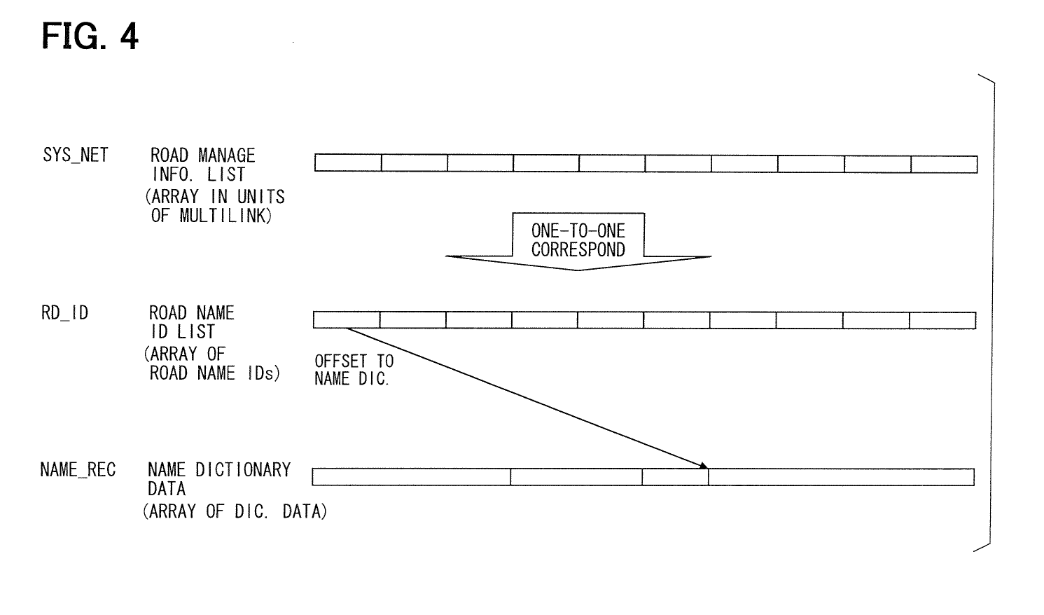

The road name ID list is a list of fixed-length offset information elements (also called road name ID elements). As shown in FIG. 4, the offset information elements in the road name ID list respectively correspond to the road management information elements in the road management information list. In the road name ID list, the offset information elements are arranged in the same order as the corresponding road management information elements are arranged in the road management information list. In the road name ID list, each offset information element indicates location of a certain road name information element in the name dictionary data, where the certain road name information element indicates road name of a road corresponding to the multilink represented by the road management information element. The road name ID list is an example of offset information list.

The road number name ID list is a list of fixed offset information elements. The offset information elements in the road number name ID list respectively correspond to the road management information elements in the road management information list. In the road number name ID list, the offset information elements are arranged in the same array order as the corresponding road management information elements are arranged in the road management information list. In the road number name ID list, each offset information element indicates location of road number information in the name dictionary data, the road number information indicating a road number of a multilink represented by the corresponding road management information element.

The name dictionary data is dictionary data about road names and road numbers. The name dictionary data stores the road name information elements each indicative road name of the corresponding multilink as well as the road number information. Together with the road number information, the road name information elements are stored and arranged in the name dictionary data in an order in which the corresponding road management element information elements are arranged in the road management information list. That is, the name dictionary data stores the information elements, each of which is variable-length and contains (i) information indicating the number of characters and (ii) a character string. The name dictionary data is an example of road name information list.

The area code list is a list of fixed-length area code information elements, which respectively correspond to multilinks, and each of which indicates a code number of an area of the corresponding multilink. In the area code list, the area code information elements are arranged in the same order as the corresponding road management information elements are arranged in the road management information list.

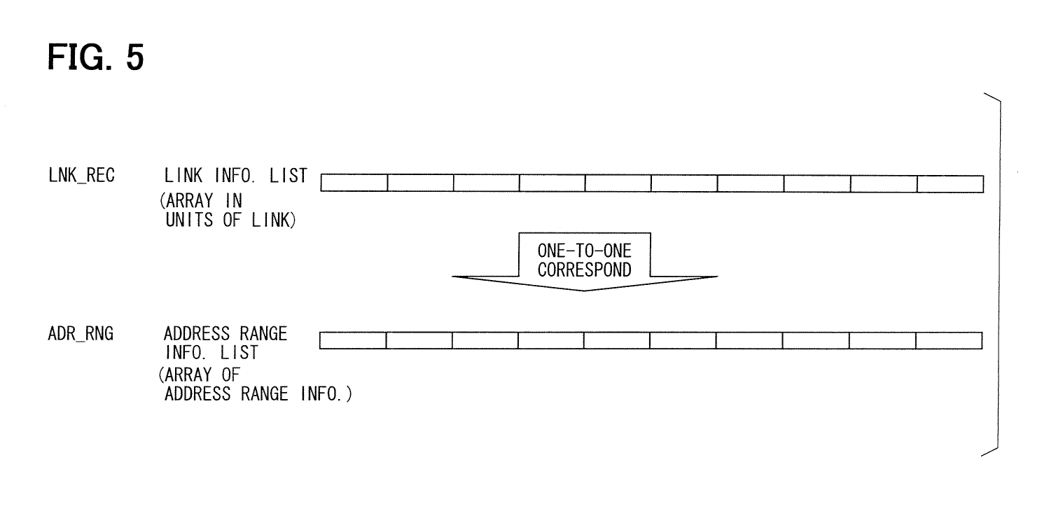

The address range information list is a list of fixed-length address range information elements. As shown in FIG. 5, the address range information elements in the address range information list have a one-to-one correspondence to the link information elements in the link information list. Each address range information element indicates a house number of a road represented by a corresponding link. In the address range information list, the address range information elements are arranged in the same order as the corresponding link information elements are arranged in the link information list.

The representative coordinate information list is a list of fixed-length representative coordinate information elements. The representative coordinate information elements respectively correspond to the links and thus the link information elements. Each representative coordinate information element indicates a representative coordinate point that is set on a corresponding link. The representative coordinate information elements are arranged in the representative coordinate information list in the same order, as the corresponding link information elements are arranged in the link information list.

The upper-level link ID list is a list of fixed-length offset information elements that respectively correspond to the links and thus the link information elements. Each offset information element indicates location of a link in upper level associated with the corresponding link. The offset information elements are arranged in the upper-level ink ID list in the same order as the corresponding link information elements are arranged in the link information list.

The boundary node number list is a list of fixed-length boundary node number information elements, which indicate coordinate points set on ends of links. The boundary node number information elements are arranged in the boundary node number list in an order in which the coordinate points are set on the links.

The compound link regulation record list is a list of fixed-length compound link regulation record information elements each indicating the presence and absence of regulation of a compound link. The compound link regulation record information elements are arranged in the compound link regulation record list in an order in which the corresponding link information elements are stored in the link information list.

<2. Acquisition of Various Information Using Map Data>

The above map data is applicable to a navigation apparatus.

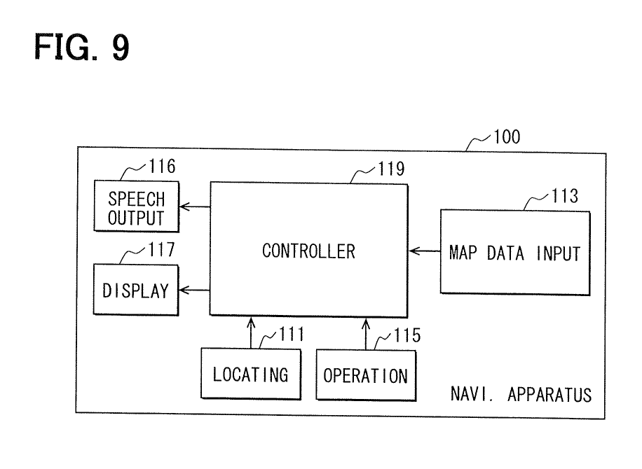

A navigation apparatus 100 of the present embodiment will be described below with reference to FIG. 9. As shown in FIG. 9, the navigation apparatus 100 includes a locating device 111, a map data input device 113, an operation device 115, a speech output device 116, a display device 117, and a controller 119. The locating device 111 locates the present position of the vehicle equipped with the navigation apparatus 100. The locating device 111 includes, for example, a gyroscope, a distance sensor, a GPS receiver and the like.

The map data input device 113 includes a hard disk drive, which can act as a computer readable storage medium storing therein the map data. The map data input device 113 can input the map data to the controller 119.

The operation device 115 allows use's instructions to be inputted to the controller 119. The operation device 115 includes a touch sensitive panel provided on the display device 117, a group of operation switches provided on a body of the navigation apparatus 100 or a remote controller, or the like. Via the operation device 115, a user can conduct various operations on the navigation apparatus 100 such as map scale change, map scroll, destination designation, and the like.

The speech output device 116 includes a speaker and the like, and outputs guidance speech or the like upon receiving a signal from the controller 119. The display device 117 can provide full-color display. The display device 117 superimposes a present position mark indicative of the present position of the vehicle detected by the locating device 111, a navigation and the like on a map image made based on the map data inputted from the map data input device 113.

The controller 119 includes a CPU, a ROM, a RAM, an I/O and a bus line connecting the foregoing components. The controller 119 may be configured as a known microcomputer. In the controller 119, the CPU performs various processes to implement navigation functions in accordance with programs stored in the ROM.

For example, the controller 119 performs a drawing process to display a map on the display device 117, a route retrieval process to retrieve a navigation route to a destination designated by a user via the operation device 115, and a route guidance process to conduct guidance of a road, a facility and the like along the navigation route.

The navigation apparatus 100 utilizes the map data 1 to perform a navigation operation incusing various processes such a route retrieval process, a map drawing process and the like through reading the map data from the map data input device 113. In performing the various processes, the navigation apparatus 100 acquires a variety of information such as road name and the like from the map data 1. In the following, a road name acquisition process using the map data 1 will be described with reference to FIGS. 3 to 5. FIG. 3 is a diagram illustrating a manner of acquiring a road management information element, a link information element and a coordinate information element (which indicate shape of the link). FIG. 4 is a diagram illustrating a manner of acquiring road name. FIG. 5 is a diagram illustrating a manner of acquiring address range information.

(1) Acquisition of Road Name from Road Link

In the road management information list, the road management information elements respectively correspond to multilinks, each of which is a group of continuous links having the same road name. As shown in FIG. 4, the road management information elements have a one-to-one correspondence to the offset information elements (also called therein the road name ID elements) of the road name ID list. Each road name ID element indicates an offset to a corresponding road name information element of the name dictionary data. Therefore, when acquiring a road name, the controller 119 of the navigation apparatus 100 acquires a road name ID element corresponding to a multilink from the road name ID list of the map data stored in the storage medium. Based on the offset indicated by the acquired road name ID element, the controller 119 can identify location of the road name stored in the name dictionary data and acquires the identified road name.

(2) Acquisition of House Number

A house number can be acquired in the following way. A road name is inputted. From the road name ID list, the controller 119 identifies a road name ID element that indicates an offset to a road name information element of the name dictionary data representing the inputted road name. Then, from the road management information list, the controller 119 identifies a road management information element that corresponds to the identified road name ID element (see FIG. 4). Then, from the link information list, the controller 119 identifies a link information element that corresponds to the identified road management information element (see FIG. 3). Further, from the address range information list, the controller 119 identifies an address range information element that corresponds to the identified link information element and the link (see FIG. 5). The address range information element indicates a house numbers of a road corresponding to the link. Thus, it is possible to identify a house number of a road from the identified address range information element and the corresponding link information element.

<3. Advantage>

The map data 1 of the present embodiment enables high speed access to data. Furthermore, according to the map data 1 of present embodiment, it is not necessary to divide road data and background data of road map data according to multiple meshes. Therefore, the map data 1 of the present embodiment has a data volume smaller than conventional map data. The map data 1 of the present embodiment can achieve both small volume and high speed access to data.

### Other Embodiments

Embodiments of the present invention are not limited to the above-described embodiments. Embodiments of the present invention can have various forms, examples of which will be described below.

According to the above-described embodiment, the road name information elements indicative of road name of the corresponding multilinks together with road numbers are stored and arranged in the name dictionary data in an order in which the corresponding road management information elements are stored and arranged in the road management information list. Alternatively, the name dictionary data may have a data structure in which the road name information elements are sorted and arranged in another other, e.g., alphabetical order. For example, the road name information elements may be arranged according to alphabetical order of road name and may be divided into multiple groups of data in units of initial character (i.e., road name initial character).

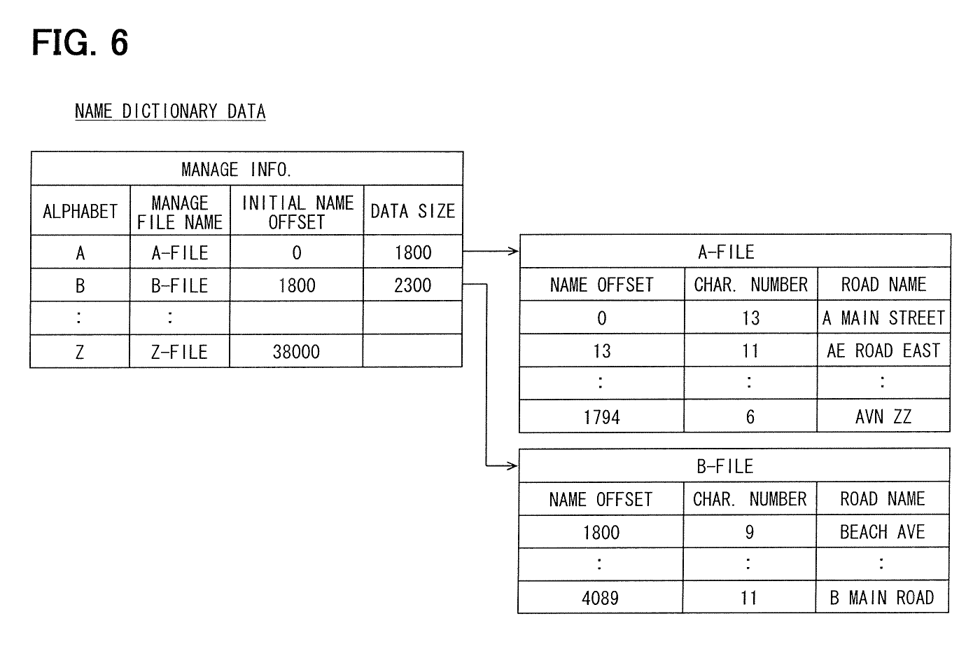

As shown in FIG. 6, the name dictionary data in which the road name information elements are sorted according to alphabetical order may include management information and multiple management files. The management information manages units of file division. The multiple management files are made according to initial character.

The management information of the name dictionary data may have the following structure. As shown in FIG. 6, for each alphabetical character (road name initial character), a management file name and an initial name offset and data size are recorded while being associated with each other. The management file names are set on an alphabetical character basis (on a road name initial character basis). The initial name offset stores an offset from (i) location of the beginning of the name dictionary data to (ii) location of the beginning of the group of data, which is made through division in units of initial character as described above. The data size indicates data size of the group of data.

As shown in FIG. 6, each management file (e.g., A-FILE, B-FILE) includes a name offset, a name character number and a road name, which are associated with each other. The name offset stores an offset (byte location) from (i) location of the beginning of the group of data to (ii) the road name. The name character number stores the number of characters of the road name. The road name stores a character string indicating the road name.

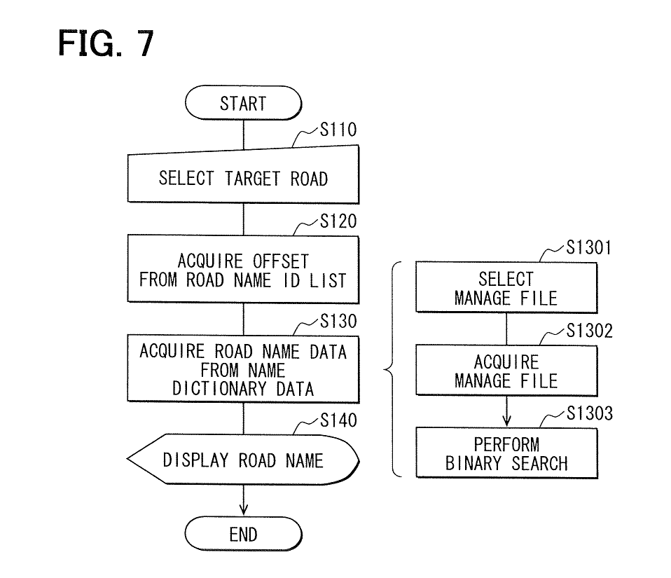

A process of acquiring a road name from the name dictionary data will be described below with reference to a flowchart of FIG. 7.

At S110, the controller 119 selects a target road, which is a road whose name is to be acquired. For example, the controller 119 accepts an input of selection of a target road from a user.

At S120, the controller 119 acquires a name offset (i.e., offset information element) corresponding to the selected road from the road name ID list (see FIG. 4).

At S130, by using the acquired name offset, the controller 119 acquires road name data from the name dictionary data (see FIG. 6). More specifically, at S1301, the controller select a management file (e.g., A-FILE) by using the name offset, and the initial name offset and the data size of the management information of the name dictionary data. At S1302, the controller acquires the selected file. At S1303, the controller 119 retrieves the name offset acquired at S120 from the acquired management file for by binary search.

At S140, the controller 119 displays the road name acquired at S130 on the display device 117. Then, the process illustrated in FIG. 7 is ended.

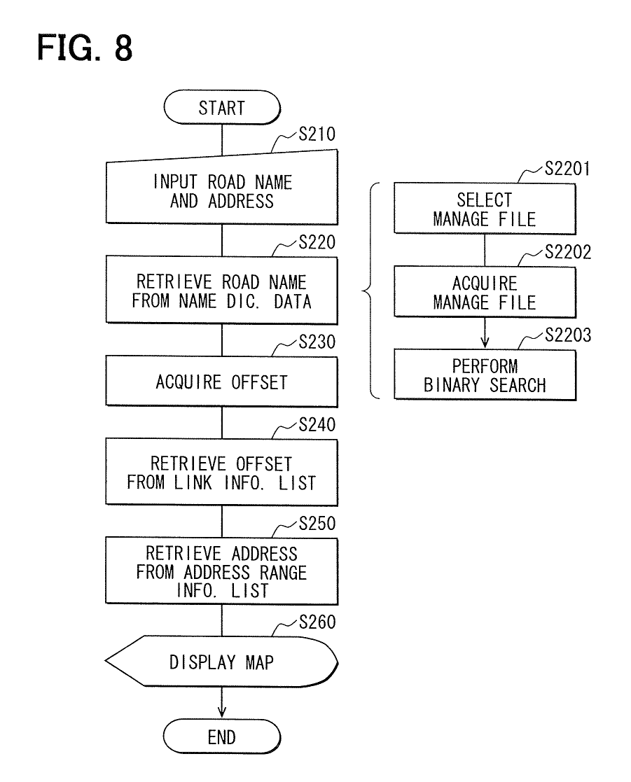

A process of performing address search will be described with reference to a flowchart of FIG. 8.

At S210, a road name and an address are inputted. For example, the controller 119 accepts an input of a road name and an address from a user.

At S220, the controller 119 searches the name dictionary data for the road name inputted at S210 (see also FIG. 6). For example, by using the management information of the name dictionary data, the controller selects at S2201 a management file (e.g., A-FILE) based on the initial character (see FIG. 6A), acquires at S2202 the selected management file (see FIG. 6B), and performs at S2203 binary search on the management file to retrieve the inputted road name.

At S230, the controller 119 acquires a name offset (offset information element) from the road name ID list by using the road name retrieved at S220.

At S240, the controller 119 retrieves a link information element corresponding to the name offset acquired at S230 from the link information list (see FIG. 5).

At S250, from the address range information list, the controller 119 retrieves an address range information element corresponding to the link information element retrieved at S240 (see FIG. 5).

At S260, the controller displays a map corresponding to an address indicated by the address range information retrieved at S250.

After S260, the process illustrated in FIG. 8 is ended.

As described above, the name dictionary data can have a data structure in which the road name information elements are arranged in an alphabetical order or the like and are divided in units of initial character. Thus, by using an alphabetical character inputted in road name retrieval, it is possible to enable high speed access to data by such search method as binary search and the like.

Since the name dictionary data are divided in units of initial character, it is possible to set a portion of the name dictionary data (which can act as the road name information list) as a search range by using an alphabetical character inputted in road name retrieval. Therefore, it is possible to further enhance the high speed access to data, compared with a case where the name dictionary data as a whole is set as a search range. In addition, it is possible to reduce amount of memory to be used. In addition, if it is necessary to reduce a total data amount of the name dictionary data, it is possible to compress the name dictionary data in units of initial alphabetical character and it is possible to use data by decompressing the data on an as-needed basis.

The name dictionary data may be sorted in an order other than European alphabetical order. That is, the name dictionary data may have a data structure in which: the road name information elements are sorted and arranged in an order that is defined as a preset arrangement order of a symbol set; and the sorted road name information elements are divided in units of initial character. The symbol set may be European alphabet, Arabian alphabet, Asian alphabet (e.g., Japanese Hiragana) or the like. The preset arrangement order of European alphabet is, for example, alphabetical order, “a, b, c, d . . . ”. Thus, the sorted road name information elements may be divided in a “a” group, a “b” group etc. according to road name initial character for instance.

The present disclosure can have the following aspects.

According to a first aspect, there is provided map data in which roads are expressed in units of link and a group of continuous links having a same attribute is defined as a multilink. The map data includes a multilink information list, a road name information list and an offset information list. The multilink information list stores therein fixed-length multilink information elements which respectively correspond to multilinks in such manner that each of the multilink information elements indicates a number of links contained in a corresponding one of the multilinks. The multilink information elements are arranged in the multilink information list in a multilink storage order. The road name information list stores therein road name information elements which respectively correspond to the multilink information elements in such manner that each of the road name information elements indicates a road name of corresponding one of the multilink information elements. The road name information elements are arranged in the road name information list in an order in which the corresponding multilink information elements are arranged in the multilink information list. The offset information list stores therein fixed-length offset information elements which respectively correspond to the road name information elements in such manner that each of the offset information elements indicates location of a corresponding one of the road name information elements in the road name information list, wherein the offset information elements are arranged in the offset information list in an order in which the corresponding multilink information elements are arranged in the multilink information list.

According to the above map data, it becomes possible to acquire an offset information element, which corresponds to a multilink information element in the multilink information list, from the multilink information list, and it becomes possible to identify the location of a road name information element in the road name information list based on the acquired offset information element. Therefore, the map data enables high speed access to data. Moreover, the map data does not require that road map data and background data are divided into data pieces corresponding to multiple meshes, the map data can have a small data amount as compared with conventional map data in which road map data and background data are divided into data pieces corresponding to multiple meshes. Therefore, the map data enables a small data amount and high speed access to data.

The above map data may further include a link information list and an address range information list. The link information list stores therein fixed-length link information elements which respectively correspond to links in such manner that each of the link information elements indicates a number of coordinate points set on the corresponding one of the links. The link information elements are arranged in the link information list in an order in which the coordinate points are set on the links. The address range information list stores therein fixed-length address range information elements which respectively correspond to the link information elements in such manner that each of the address range information elements indicates a house number of a road represented by a corresponding one of the links. The address range information elements are arranged in the address range information list in an order in which the corresponding link elements are arranged in the link information list.

According to the above map data, when a road name information element is designated for example, an offset information element having an offset to the designated road name information element can be identified from the offset information list. A multilink information element corresponding to and associated with the identified offset information element can be identified from the multilink information list. Then, a set of link information elements corresponding to and associated with the identified multilink information element can be identified from the link information list. Then, an address range information element corresponding to and associated with the identified link information element can be identified from the address range information list. Since the address range information element indicates a house number of a road of the link corresponding to the identified link information element, it is possible to identify the house number of the link from the identified address range information element and the identified link information element. Therefore, high speed access to data is possible. Moreover, the map data does not require that road map data and background data are divided into data pieces corresponding to multiple meshes, the map data can have a small data amount as compared with conventional map data in which road map data and background data are divided into data pieces corresponding to multiple meshes. Therefore, the map data enables a small data amount and high speed access to data.

According to a second aspect, there is provide map data in which roads are expressed in units of link and a group of continuous links having a same attribute is defined as a multilink. The map data includes a multilink information list, a road name information list and an offset information list. The multilink information list stores therein fixed-length multilink information elements which respectively correspond to multilinks in such manner that each of the multilink information elements indicates a number of links contained in a corresponding one of the multilinks. The multilink information elements are arranged in the multilink information list in a multilink storage order. The road name information list stores therein road name information elements which respectively correspond to the multilink information elements in such manner that each of the road name information elements indicates a road name of a corresponding one of the multilink information elements. The road name information elements are arranged in the road name information list in an order that is defined as a preset arrangement order of a symbol set. The offset information list stores therein fixed-length offset information elements which respectively correspond to the road name information elements in such manner that each of the offset information elements indicates location of a corresponding one of the road name information elements in the road name information list. The offset information elements are arranged in the offset information list in an order in which the corresponding multilink information elements are arranged in the multilink information list.

The symbol set may be European alphabet, Arabian alphabet, Asian alphabet (e.g., Japanese Hiragana). The preset arrangement order of European alphabet is, for example, an alphabetical order, “a, b, c, d . . . ” According to the above map data, by using a symbol inputted in road name retrieval, high speed access to data can be made with, for example, such search method as binary search and the like.

The above map data may be configured in the following way. The road name information list has a data structure in which the road name information elements sorted in the preset arrangement order of the symbol set are divided in units of initial character.

According to the above map data, by using a symbol inputted in road name retrieval, a portion of the road name information list can be set as a search range, and high speed data access becomes possible as compared with a case where the road name information list as a whole can be set as a search range. In addition, it is possible to reduce an amount of memory to be used. In addition, if it is necessary to reduce a total data amount of the road name information list, it is possible to allow data compression in units of initial symbol and it is possible to use data by decompressing the data on an as-needed basis.

While the invention has been described above with reference to various embodiments thereof, it is to be understood that the invention is not limited to the above described embodiments and construction. The invention is intended to cover various modification and equivalent arrangements. In addition, while the various combinations and configurations described above are contemplated as embodying the invention, other combinations and configurations, including more, less or only a single element, are also contemplated as being within the scope of embodiment.

What is claimed is:

1. Map data in which roads are expressed in units of link and a group of continuous links having a same attribute is defined as a multilink, the map data comprising:
a multilink information list that stores therein fixed-length multilink information elements which respectively correspond to multilinks in such manner that each of the multilink information elements indicates a number of links contained in a corresponding one of the multilinks, wherein the multilink information elements are arranged in the multilink information list in a multilink storage order;
a road name information list that stores therein road name information elements which respectively correspond to the multilink information elements in such manner that each of the road name information elements indicates a road name of corresponding one of the multilink information elements, wherein the road name information elements are arranged in the road name information list in an order in which the corresponding multilink information elements are arranged in the multilink information list; and
an offset information list that stores therein fixed-length offset information elements which respectively correspond to the road name information elements in such manner that each of the offset information elements indicates location of a corresponding one of the road name information elements in the road name information list, wherein the offset information elements are arranged in the offset information list in an order in which the corresponding multilink information elements are arranged in the multilink information list.

2. The map data according to claim 1, further comprising:
a link information list that stores therein fixed-length link information elements which respectively correspond to links in such manner that each of the link information elements indicates a number of coordinate points set on the corresponding one of the links, wherein the link information elements are arranged in the link information list in an order in which the coordinate points are set on the links; and
an address range information list that stores therein fixed-length address range information elements which respectively correspond to the link information elements in such manner that each of the address range information elements indicates a house number of a road represented by a corresponding one of the links, wherein the address range information elements are arranged in the address range information list in an order in which the corresponding link elements are arranged in the link information list.

3. Map data in which roads are expressed in units of link and a group of continuous links having a same attribute is defined as a multilink, the map data comprising:
a multilink information list that stores therein fixed-length multilink information elements which respectively correspond to multilinks in such manner that each of the multilink information elements indicates a number of links contained in a corresponding one of the multilinks, wherein the multilink information elements are arranged in the multilink information list in a multilink storage order;
a road name information list that stores therein road name information elements which respectively correspond to the multilink information elements in such manner that each of the road name information elements indicates a road name of a corresponding one of the multilink information elements, wherein the road name information elements are arranged in the road name information list in an order that is defined as a preset arrangement order of a symbol set; and
an offset information list that stores therein fixed-length offset information elements which respectively correspond to the road name information elements in such manner that each of the offset information elements indicates location of a corresponding one of the road name information elements in the road name information list, wherein the offset information elements are arranged in the offset information list in an order in which the corresponding multilink information elements are arranged in the multilink information list.

4. The map data according to claim 3, wherein:
the road name information list has a data structure in which
the road name information elements sorted in the preset arrangement order of the symbol set are divided in units of initial character.

5. A computer readable storage medium storing therein map data recited in claim 1.

6. A computer readable storage medium storing therein map data recited in claim 3.

7. A navigation apparatus comprising:
a map data input device storing therein map data recited in claim 1; and
a controller configured to read the map data from the map data input device to perform a navigation operation.

8. A navigation apparatus comprising:
a map data input device storing therein map data recited in claim 3; and
a controller configured to read the map data from the map data input device to perform a navigation operation.
